(19) United States
(12) Patent Application Publication
(10) Pub. No.: US 2009/0154457 A1
(43) Pub. Date: Jun. 18, 2009

(54) ENHANCING RELIABILITY OF MULTICASTING AND BROADCASTING SERVICES (MBS) OVER BROAD BAND WIRELESS ACCESS (BWA) NETWORKS

(76) Inventors: Abhijeet Kolekar, Hillsboro, OR (US); Muthaiah Venkatachalam, Beaverton, OR (US)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/958,843

(22) Filed: Dec. 18, 2007

(51) Int. Cl. H04L 12/56

(52) U.S. Cl. 370/390

(57) ABSTRACT

A broad-band wireless access (BWA) network may support high bandwidth, which may allow video multicast and broadcast services (MBS) over the BWA networks. The BWA network may comprise a base station and mobile subscriber stations provisioned in each wireless cell. The base station may select feedback leaders, which includes a sub-set of the mobile subscriber stations. The base station may send a first request to the feedback leaders and receive a response to the first request that is to indicate whether a packet transmitted prior to sending the first request is to be retransmitted. The feedback leaders may provide a feedback on the first channel, while watching a second channel. Also, the feedback leaders may provide feedback on the first channel while watching the first channel itself. Such an approach may enhance the reliability of the MBS over BWA networks.

### BACKGROUND

A broad-band wireless access (BWA) network may support data, voice, and video multicasting and broadcasting services (MBS) as BWA networks comprise high bandwidth. A large number of mobile subscriber stations (MSS) may be present in the BWA network and the MSS may move from one wireless cell to other. While delivering MBS, the MSSs in the multicast group may provide feedback, which may be treated as noise on the feedback channel. The feedback from the MSSs of the multicast group may result in collision of ACK/NACKs, which may increase retransmissions and delay in error recovery. The retransmissions may consume bandwidth.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 is a wireless environment, which includes one or more mobile stations and base stations that enhance reliability of MBS over WBA network according to one embodiment.

FIG. 2 is a flow-diagram, which illustrates an operation of feedback leaders and the base station to enhance reliability of MBS over WBA network according to one embodiment.

FIG. 3 is a sequence diagram, which illustrates signals exchanged between a feedback leader and the base station to enhance reliability of MBS over WBA network according to one embodiment.

FIG. 4 is a flow-diagram, which illustrates an operation of the feedback leaders and the base station to enhance reliability of MBS over WBA network according to other embodiment.

FIG. 5 is a sequence diagram, which illustrates signals exchanged between a feedback leader and the base station to enhance reliability of MBS over WBA network according to other embodiment.

### DETAILED DESCRIPTION

The following description describes embodiments of enhancing reliability of multicast and broadcast video streaming over BWA networks. In the following description, numerous specific details such as logic implementations, resource partitioning, or sharing, or duplication implementations, types and interrelationships of system components, and logic partitioning or integration choices are set forth in order to provide a more thorough understanding of the present invention. It will be appreciated, however, by one skilled in the art that the invention may be practiced without such specific details. In other instances, control structures, gate level circuits, and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device).

For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, and digital signals). Further, firmware, software, routines, and instructions may be described herein as performing certain actions. However, it should be appreciated that such descriptions are merely for convenience and that such actions in fact result from computing devices, processors, controllers, and other devices executing the firmware, software, routines, and instructions.

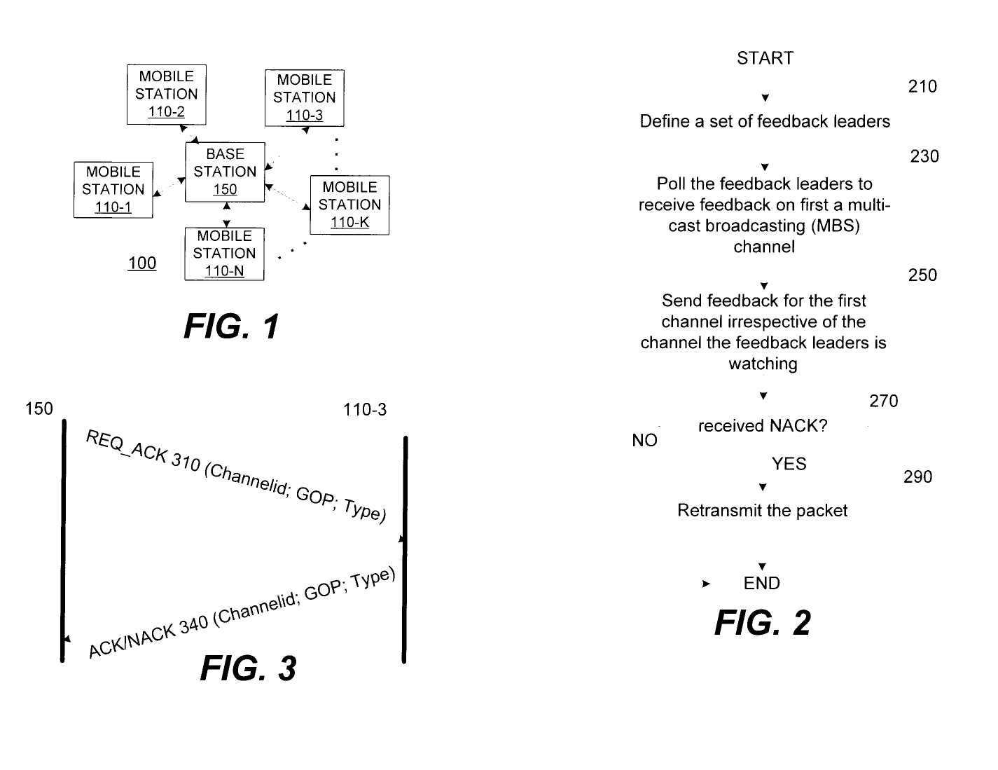

A wireless cell 100 including one or more mobile stations and base stations, which may enhance reliability of MBS in a BWA network in accordance with one embodiment is illustrated in FIG. 1. In one embodiment, the wireless cell 100 may comprise one or more mobile subscriber stations MSS110-1 to MSS110-N and a base station (BS) 150.

In one embodiment, the base station 150 may support video MBS as the base station 150 may support high bandwidth. In one embodiment, a video packet, which is multicast or broadcast may comprise I-frames, B-frames, and P-frames. In one embodiment, the I-frames may be associated with higher priority as compared to B-frames and P-frames. In one embodiment, the base station 150 may support features, which may enhance reliability of MBS over BWA networks.

In one embodiment, the base station 150 may select a set of feedback leaders from which a feedback may be received. In one embodiment, the number of feedback leaders selected may determine based on the frames that the video packet comprise. In one embodiment, the number of feedback leaders selected may be high while transmitting I-frames as compared to B-frames and P-frames. In one embodiment, the number of feedback leaders (M) may be lesser than the total number of MSSs (N). In one embodiment, the base station 150 may select MSS 101-1, 101-3, and 101-K as feedback leaders.

In one embodiment, the base station 150 may support wireless channels (e.g., channel-A, channel-B, channel-C, and channel-D) and the base station 150 may request MSS101-1, 101-3, and 101-K to provide feedback on channel-A, for example. In one embodiment, the base station 150 may not check the channel which the feedback leaders MSS101-1, 101-2, and 101-K may be tuned into before sending the request. In one embodiment, the request may comprise control information such as the channel identifier (channel_id), group of pictures (GOP), and the type fields. In one embodiment, the channel for which the feedback is requested may be determined based on the contents of channel_id field. In one embodiment, the base station 150 receive feedback (ACK or NACK) for channel-A from the feedback leaders MSS 101-1, 101-3, and 101-K. If the feedback received is NACK, the base station 150 may probabilistically retransmit the video packets.

As the number of feedback leaders (M) is less than the total number of MSSs (N) provisioned in the wireless cell 100, the feedback signals may also be less compared to all the MSSs providing the feedback. As a result, the amount of ACK/NACK and the amount of retransmissions may decrease. In one embodiment, the feedback from the selected feedback leaders may enhance reliability and conserve bandwidth by decreasing the noise on the feedback channel.

In other embodiment, the base station 150 may check the channel that the feedback leaders MSS101-1, 101-3, and 101-K are tuned into and may send a request for getting a feedback on the same channel that the feedback leaders MSS101-1, 101-3, and 101-K are tuned into. In one embodiment, the base station 150 may vary the number of feedback leaders and may select different feedback leaders at different intervals of time in a round-robin fashion. In one embodiment, the number of feedback leaders may depend on the type of frames transmitted in video packets.

In other embodiment, the base station 150 may change the modulation and coding (MCS) schemes for the packet transmissions to further enhance the reliability of MBS over the BWA networks. In one embodiment, the base station 150 may determine the modulation and coding scheme to be used based on the feedback received from the feedback leaders over a time window.

In one embodiment, the base station 150 may support standards based broad-band wireless access technologies such as wireless microwave access for interoperability (Wi-MAX). In one embodiment, the base station 150 may support standards such as IEEE 802.16.

In one embodiment, the feedback leaders may receive the request from the base station 150 and generate a feedback comprising ACK or a NACK. In one embodiment, the feedback leaders MSS101-1 and 101-N may receive a request and identify the channel based on the contents of the channel id information. In one embodiment, the channel_id information may identify the channel-A, while the MSS101-1, 101-3, and 101-K may be tuned to channel-C. However, the MSS101-1, 101-3, and 101-K may provide feedback on the channel-A. In one embodiment, the feedback may comprise ACK (acknowledgement) if the MSS 101-1, 101-3, and 101-K successfully decodes the video packet and NACK (non-acknowledge) otherwise.

In other embodiment, the MSS101-1, 101-3, and 101-K may receive a request to provide feedback on the channel that the MSS101-1, 101-3, and 101-K may be tuned into. If the request for feedback is for a channel which the MSS 101-1, 101-3, and 101-K are tuned into, the MSS 101-1, 101-3, and 101-K may not retrieve the channel_id to identify the channel. In one embodiment, the channel_id field may be set to a default value to indicate that the feedback is requested for the channel which the feedback leaders MSS101-1, 101-3, and 101-K are tuned into.

A flow-diagram illustrating an operation of feedback leaders and base station, which may enhance reliability of video MBS over WBA network according to one embodiment, is depicted in FIG. 2.

In block 210, the base station 150 may define a set of feedback leaders such as MSS101-1, 101-3, and 101-K. In one embodiment, the base station 150 may select M feedback leaders from a total of N (N>M) mobile subscriber stations 101-1 to 101-N. In one embodiment, the value of M may change based on the type of frames that a video packet may carry. In one embodiment, the base station 150 may select the feedback leaders based on a round-robin fashion.

In block 230, the base station 150 may poll the feedback leaders MSS101-1, 101-3, and 101-K to receive a feedback on a channel identified by the base station 150. In one embodiment, the base station 150 may identify channel-A and poll the feedback leaders MSS 101-1, 101-1, and 101-K to receive the feedback on the channel-A. In one embodiment, the base station 150 may send a request to the feedback leaders 101-1, 101-3, and 101-K and the request may comprise control information such as a channel_id, which may equal the identifier of the channel-A.

In block 250, the feedback leaders 101-1, 101-3, and 101-N may send a feedback for the channel-A. In one embodiment, the feedback leaders may use the channel_id of the request to identify the channel for which a feedback is to be sent. In one embodiment, the feedback leaders may be watching a different channel-B, or C, or D and irrespective of the channel the feedback leaders are watching, a feedback on the channel-A is sent to the base station 150. In one embodiment, the feedback leaders 101-1, 101-3, and 101-K may send ACK after decoding the video packet and may send NACK otherwise.

In block 270, the base station 150 may check whether the feedback equals NACK and control passes to block 290 if the feedback is NACK and the process ends otherwise. In block 290, the base station 150 may retransmit the video packet.

A sequence diagram, which illustrates the signals exchanged between a feedback leader and the base station to enhance reliability of MBS over WBA network according to one embodiment, is depicted in FIG. 3.

In one embodiment, the base station 150 may send a request REQ_ACK 310 to the feedback leaders MSS101-1, 101-3, and 101-K. In one embodiment, the request may comprise control info such as channel_id; GOP; and type fields. In one embodiment, the feedback leaders may respond to the request REQ_ACK 310 by sending a ACK/NACK 340. In one embodiment, the feedback leaders MSS101-1, 101-3, and 101-K may use the channel_id to identify the channel for which a feedback is to be sent. In one embodiment, the feedback leaders may send either ACK or NACK based on whether the feedback leader decoded the video packet.

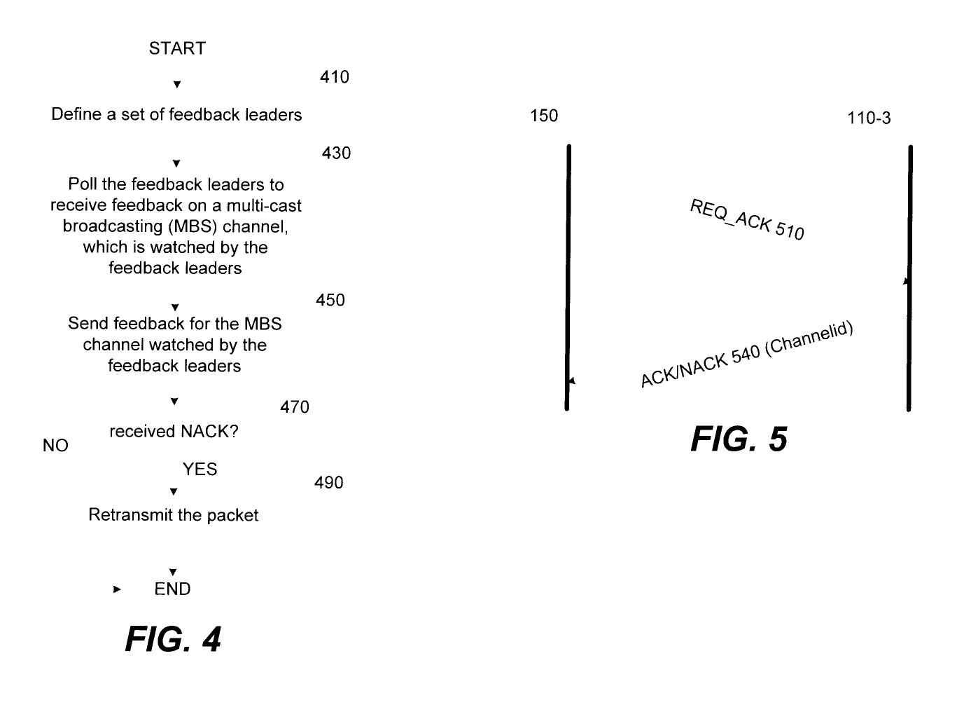

A flow-diagram, which illustrates an operation of the feedback leaders and the base station to enhance reliability of MBS over WBA network according to other embodiment, is depicted in FIG. 4.

In block 410, the base station 150 may define a set of feedback leaders such as MSS101-1, 101-3, and 101-K. In one embodiment, the base station 150 may select M feedback leaders from a total of N (N>M) mobile subscriber stations 101-1 to 101-N. In one embodiment, the value of M may change based on the type of frames that a video packet may carry. In one embodiment, the base station 150 may select the feedback leaders based on a round-robin fashion.

In block 430, the base station 150 may poll the feedback leaders MSS101-1, 101-3, and 101-K to receive a feedback on a MBS channel, which is watched by the feedback leaders MSS101-1, 101-3, and 101-K.

In block 450, the feedback leaders 101-1, 101-3, and 101-N may send a feedback for the channel-A, which is watched by the feedback leaders. In one embodiment, the feedback leaders 101-1, 101-3, and 101-K may send ACK after decoding the video packet and may send NACK otherwise.

In block 470, the base station 150 may check whether the feedback equals NACK and control passes to block 490 if the feedback is NACK and the process ends otherwise. In block 490, the base station 150 may retransmit the video packet.

A sequence diagram, which illustrates the signals exchanged between a feedback leader and the base station to enhance reliability of MBS over WBA network according to one embodiment, is depicted in FIG. 5.

In one embodiment, the base station 150 may send a request REQ_ACK 510 to the feedback leader MSS101-3. In one embodiment, the feedback leader MSS101-3 may respond to the request REQ_ACK 510 by sending ACK/NACK 540. In one embodiment, the ACK/NACK540 may comprise a channel_id for the base station 150 to identify the channel for which a feedback is sent. In one embodiment, the feedback leaders may send either ACK or NACK based on whether the feedback leader decoded the video packet.

Certain features of the invention have been described with reference to example embodiments. However, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. A method comprising:
selecting a first set of mobile subscriber stations of a plurality of mobile subscriber stations,
sending a first request to the first set of mobile subscriber stations, wherein the first set of mobile subscriber stations are to provide a feedback on a first channel,
receiving a response to the first request, wherein the response to the first request is to indicate whether a packet transmitted prior to sending the first request is to be retransmitted.

2. The method of claim 1, wherein the response to the first request is generated by the first set of mobile subscriber stations while the first set of mobile subscriber stations is watching a second channel.

3. The method of claim 2, wherein the first channel is identified using a channel identifier field of the first request.

4. The method of claim 1, wherein the response to the first channel is generated by the first set of mobile subscriber stations while the first set of mobile subscriber stations are watching the first channel.

5. The method of claim 4 further comprises sending the channel identifier of the first channel while sending the response to the first request.

6. The method of claim 1, wherein the first set of mobile subscriber stations selected to provide feedback is less than the plurality of mobile subscriber stations provisioned in a wireless cell.

7. The method of claim 6, wherein a broad-band wireless access network comprises the wireless cell, wherein the wireless cell includes the plurality of mobile subscriber stations.

8. The method of claim 7, wherein the broad-band wireless network is to support multicasting and broadcasting services of video packets.

9. The method of claim 8 further comprises changing the number of mobile subscriber stations in the first set of mobile subscriber stations based on the type of frames sent in a video packet.

10. The method of claim 8 further comprises selecting a second set of mobile subscriber stations to provide a feedback to the first request, wherein the second set of mobile subscriber stations is selected from the plurality of mobile subscriber stations in a round-robin fashion.

11. The method of claim 10 further comprises changing the number of mobile subscriber stations in the second set of mobile subscriber stations based on the type of frames sent in the video packet.

12. An apparatus comprising:
a base station provisioned in a wireless cell, and
a plurality of mobile subscriber stations provisioned in the wireless cell, wherein the plurality of mobile subscriber stations are coupled to the base station,
wherein the base station is to select a first set of mobile subscriber stations of the plurality of mobile subscriber stations,
wherein the base station is to send a first request to the first set of mobile subscriber stations,
wherein the base station is to receive a response to the first request that is to indicate whether a packet transmitted prior to sending the first request is to be retransmitted, and
wherein the first set of mobile subscriber stations are to provide a feedback on a first channel.

13. The apparatus of claim 12, wherein the first set of mobile subscriber stations is to generate the response to the first request while the first set of mobile subscriber stations is watching a second channel.

14. The apparatus of claim 13, wherein the first set of mobile subscriber stations is to identify the first channel using a channel identifier field of the first request.

15. The apparatus of claim 12, wherein the first set of mobile subscriber stations is to generate the response to the first channel while the first set of mobile subscriber stations is watching the first channel.

16. The apparatus of claim 15, wherein the first set of mobile subscriber stations is to send the channel identifier of the first channel while sending the response to the first request.

17. The apparatus of claim 12, wherein the base station is to select the first set of mobile subscriber stations that is a sub-set of the plurality of mobile subscriber stations provisioned in a wireless cell.

18. The apparatus of claim 17, wherein a broad-band wireless access network comprises the wireless cell, wherein the wireless cell includes the plurality of mobile subscriber stations and the base station.

19. The apparatus of claim 18, wherein the base station and the plurality of mobile subscriber stations is to support multicasting and broadcasting services of video packets.

20. The apparatus of claim 19, wherein the base station is to change the number of mobile subscriber stations in the first set of mobile subscriber stations based on the type of frames sent in a video packet.

21. The apparatus of claim 19, wherein the base station is to select a second set of mobile subscriber stations to provide a feedback to the first request, wherein the second set of mobile subscriber stations is selected from the plurality of mobile subscriber stations in a round-robin fashion.

22. The apparatus of claim 21, wherein the base station is to change the number of mobile subscriber stations in the second set of mobile subscriber stations based on the type of frames sent in the video packet.
